(19) United States
(12) Patent Application Publication
(10) Pub. No.: US 2025/0277893 A1
(43) Pub. Date: Sep. 4, 2025

(54) LIGHT GUIDE WITH TWO REFLECTIVE SURFACES AND NAVIGATION SENSOR USING THE SAME

(71) Applicant: PIXART IMAGING INC., Hsin-Chu County (TW)

(72) Inventors: Yee-Loong CHIN, Penang (MY); Hun-Kwang LEE, Penang (MY); Sai-Mun LEE, Penang (MY)

(21) Appl. No.: 18/594,042

(22) Filed: Mar. 4, 2024

(51) Int. Cl. G01S 7/481; G02B 6/26

(52) U.S. Cl. CPC G01S 7/4811; G02B 6/262

(57) ABSTRACT

There is provided a navigation sensor including a light source, a light sensor and a light guide. The light guide includes a first reflective surface opposite to the light source and used to transversely reflect an emission light beam of the light source coming from a first surface of the light guide. The light guide further includes a second reflective surface to reflect the transverse light beam coming from the first reflective surface toward a second surface of the light guide such that an outgoing light beam from the light guide is closer to the image sensor to increase a working depth of field.

### FIELD OF THE DISCLOSURE

This disclosure generally relates to a navigation sensor and, more particularly, to an optical navigation sensor that has a light guide arranged with two reflective surfaces therein to reduce an included angle between an outgoing light beam of the light guide and a longitudinal direction so as to increase a working depth of field thereof, and a light guide of the navigation sensor.

### BACKGROUND OF THE DISCLOSURE

Please refer to FIG. 1, it is a cross sectional view of a conventional navigation sensor 100. The navigation sensor 100 includes a light source 11, a light sensor 13 and a light guide 12. The light guide 12 includes a first lens Lens1, which is opposite to the light source 11 and used to receive an emission light beam of the light source 11, a second lens Lens2, through which the emission light beam leaves the light guide 12 to form an illumination light beam 90 to illuminate a working surface WS, and a third lens Lens3, which is to receive diffuse reflection light of the illumination light beam 90 reflected by the working surface WS.

A working range (shown as DOF) of the navigation sensor 100 is determined according to a crossing range between a field of view of the light sensor 13 (e.g., indicated by a center line of field of view C__{FOV} for simplifying illustrations) and the illumination light beam 90. As shown in FIG. 1, the minimum operable distance (e.g., shown as Near-end) and the maximum operable range (e.g., shown as Far-end) of the working surface WS determine the DOF. When the working surface WS is outside the DOF, the diffuse reflection light cannot be received by the light sensor 13.

Due to opto-mechanical design constraints of the navigation sensor 100, the illumination light beam 90 has a large included angle θ with respect to the center line C__{FOV} that can limit the DOF of the navigation sensor 100.

The information disclosed in the BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides a navigation sensor that has a light guide arranged with two reflective surfaces therein to perform two times of reflection on an emission light beam such that the illumination light beam is close to a light sensor as much as possible in a transverse direction so as to increase a crossing range between the illumination light beam and a field of view of the light sensor thereby increasing a working range of the navigation sensor, and a light guide of the navigation sensor.

The present disclosure further provides a navigation sensor that generates a divergent illumination light beam to further increase a crossing range between the illumination light beam and a field of view of the light sensor, and a light guide thereof.

The present disclosure provides a navigation sensor including a substrate, a light sensor, a light source and a light guide. The light sensor is arranged on the substrate. The light source is arranged on the substrate and located at a side of the light sensor, and configured to generate an emission light beam. The light guide includes a first lens, a first reflective surface, a second reflective surface and a second lens, wherein the emission light beam enters the light guide via the first lens, the first reflective surface is opposite the first lens and configured to transversely reflect the emission light beam inside the light guide, and the second reflective surface is configured to reflect the reflected emission light beam toward the second lens to generate an illumination light beam leaving the light guide via the second lens, wherein the second reflective surface is located between the light sensor and the first reflective surface in a transverse direction.

The present disclosure further provides a navigation sensor including a substrate, a light sensor, a light source and a light guide. The light sensor is arranged on the substrate. The light source is arranged on the substrate and located at a side of the light sensor, and configured to generate an emission light beam. The light guide includes a first lens, a first reflective surface, a second reflective surface and a second lens, wherein the emission light beam enters the light guide via the first lens, the first reflective surface is opposite the first lens and configured to transversely reflect the emission light beam inside the light guide, and the second reflective surface is configured to reflect the reflected emission light beam toward the second lens to generate an illumination light beam leaving the light guide via the second lens, wherein the light sensor is located between the second reflective surface and the first reflective surface in a transverse direction.

The present disclosure further provides a light guide of a navigation sensor including an upper surface, a bottom surface, a first lens, a first reflective surface, a second lens and a second reflective surface. The first lens is located at the upper surface, and configured to receive an emission light beam of a light source. The first reflective surface is opposite to the first lens, and configured to transversally reflect the emission light beam coming from the first lens inside the light guide. The second lens is located at the bottom surface. The second reflective surface is opposite to the second lens, and configured to reflect the reflected emission light beam toward the second lens, wherein the first reflective surface and the second reflective surface are total internal reflection surfaces formed by a first interface and a second interface between molding material of the light guide and air.

### BRIEF DESCRIPTION OF DRAWINGS

Other objects, advantages, and novel features of the present disclosure will become more apparent from the following detailed description when taken in conjunction with the accompanying drawings.

FIG. 1 is a cross sectional view of a conventional navigation sensor.

FIG. 2 is a cross sectional view of a navigation sensor according to a first embodiment of the present disclosure.

FIG. 3 is a cross sectional view of a navigation sensor according to a second embodiment of the present disclosure.

FIG. 4 is a cross sectional view of a navigation sensor according to a third embodiment of the present disclosure.

FIG. 5 is a cross sectional view of a navigation sensor according to a fourth embodiment of the present disclosure.

FIG. 6 is a schematic diagram of spatial relationship of components in a transverse direction of a navigation sensor of the embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a navigation sensor that has a light guide to reflect an emission light beam of a light source by two times to move a transverse position of an illumination light beam outgoing from the light guide to be close to a light sensor. In this way, a field of view of the light sensor has a longer crossing range with the illumination light beam to increase an operable working range. Furthermore, the operable working range is further increased by arranging the illumination light beam as a divergent light beam.

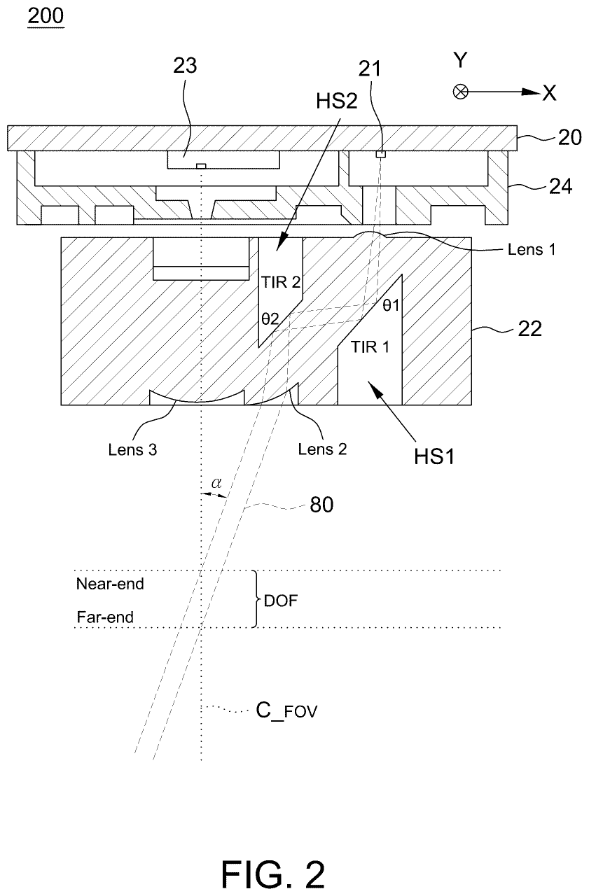

Please refer to FIG. 2, it is a cross sectional view of a navigation sensor 200 according to a first embodiment of the present disclosure. The navigation sensor 200 includes a substrate 20, a light source 21, a light sensor 23, a light guide 22 and a light blocking member 24, wherein the light guide 22 is preferably made of transparent material, e.g., formed by molding glass material or plastic material, but not limited to. The light blocking member 24 is preferably made of opaque material, e.g., formed by molding plastic material or rubber material, but not limited to.

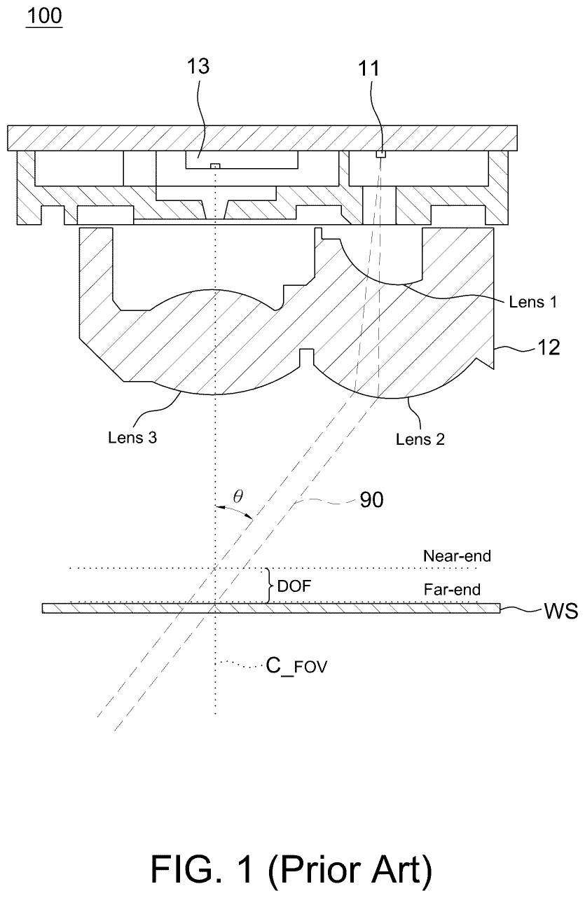

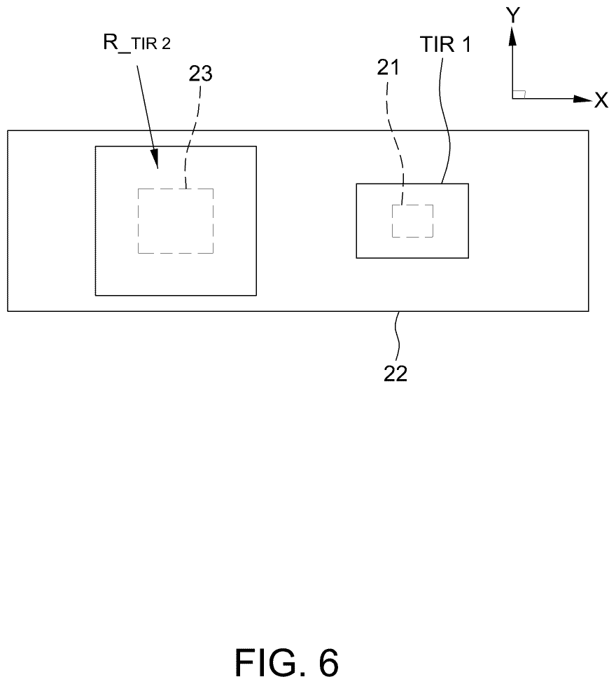

The substrate 20 is, for example, a printed circuit board or a flexible board without particular limitations. The light source 21, the light sensor 23 and the light blocking member 24 are arranged on the substrate 20. The light source 21 is arranged at a side of the light sensor 23, e.g., X-direction shown in FIGS. 1 and 6. FIG. 6 is a schematic diagram of the spatial relationship of components in the transverse direction (e.g., including X-direction and Y-direction) of a navigation sensor of every embodiment of the present disclosure.

For example, the light blocking member 24 has a first accommodation space for accommodating the light source 21. The first accommodation space has a first opening to allow an emission light beam of the light source 21 to pass through. The light blocking member 24 further has a second accommodation space for accommodating the light sensor 23. The second accommodation space has a second opening to allow an incident light beam of the light sensor 23 to pass through, referring to FIG. 2.

The light source 21 is a coherent light source, a partially coherent light source or a non-coherent light source, e.g., a light emitting diode, a laser diode or a VCSEL, but not limited thereto. The light source 21 emits light of an identifiable spectrum, e.g., red light and/or infrared light, but not limited to.

The light sensor 23 is a complementary metal oxide semiconductor (CMOS) image sensor or a single photon avalanche diode (SPAD) image sensor or a charge-coupled device (CCD) image sensor, but not limited to. A field of view of the light sensor 23 has a center line C__{FOV}. It should be mentioned that although the center line C__{FOV} is shown to be perpendicular to a working surface (e.g., referring to WS shown in FIG. 1), the present disclosure is not limited thereto. The center line C__{FOV} may be arranged to have an inclined angle.

The light guide 22 has an upper surface (e.g., a surface facing the substrate 20), a bottom surface (e.g., a surface facing the working surface), and a lateral surface connecting the upper surface and the bottom surface. The light guide 22 includes at least a first lens Lens1, a first reflective surface TIR1, a second reflective surface TIR2, a second lens Lens2 and a third lens Lens3.

In one aspect, the first lens Lens1 is a convex lens, the first reflective surface TIR1 is a plano-surface, the second reflective surface TIR2 is a plano-surface, and the second lens Lens2 is a convex lens. In another aspect, the first lens Lens1 is a convex lens, the first reflective surface TIR1 is a concave surface, the second reflective surface TIR2 is a plano-surface, and the second lens Lens2 is a convex lens. In a further aspect, the first lens Lens1 is a plano-lens, the first reflective surface TIR1 is a concave surface, the second reflective surface TIR2 is a concave surface, and the second lens Lens2 is a convex lens. In a further aspect, the first lens Lens1 is a plano-lens, the first reflective surface TIR1 is a concave surface, the second reflective surface TIR2 is a concave surface, and the second lens Lens2 is a tilted plano-lens, a wedge or a prism. In a further aspect, the first lens Lens1 is a concave lens, the first reflective surface TIR1 is a concave surface, the second reflective surface TIR2 is a plano-surface, and the second lens Lens2 is a convex lens. In a further aspect, the first lens Lens1 is a concave lens, the first reflective surface TIR1 is a concave surface, the second reflective surface TIR2 is a concave surface, and the second lens Lens2 is a convex lens. In a further aspect, the first lens Lens1 is a concave lens, the first reflective surface TIR1 is a concave surface, the second reflective surface TIR2 is a concave surface, and the second lens Lens2 is a tilted plano-lens. The third lens Lens3 is, for example, a convex lens.

The first lens Lens1 is located at the upper surface of the light guide 22, and used to receive an emission light beam (e.g., shown by dashed line) of the light source 21 to allow the emission light beam to enter the light guide 22 via the first lens Lens1.

The first reflective surface TIR1 is opposite to the first lens Lens1 (e.g., the first lens Lens1 shown to be above the first reflective surface TIR1 in FIG. 2), and is used to transversally reflect the emission light beam coming from the first lens Lens1 inside the light guide 22.

The second lens Lens2 is located at the bottom surface of the light guide 22.

The second reflective surface TIR2 is opposite to the second lens Lens2 (e.g., the second reflective surface TIR2 shown to be above the second lens Lens2 in FIG. 2), and is used to reflect the reflected emission light beam (e.g., transverse light beam) toward the second lens Lens2 to generate an illumination light beam 80 leaving the light guide 22 from the second lens Lens2. The first reflective surface TIR1 and the second reflective surface TIR2 are located at an identical height or different heights inside the light guide 22.

The third lens Lens3 is located at the bottom surface of the light guide 22 and opposite to the light sensor 23. That is, the diffuse reflection light of the illumination light beam 80 reflected by the working surface enters the light guide 22 via the third lens Lens3 and then propagates to the light sensor 23 after passing the light blocking member 24.

In the present disclosure, the first reflective surface TIR1 and the second reflective surface TIR2 are total internal reflection surfaces formed by an interface between molding material (e.g., glass or plastic, but not limited to) of the light guide 22 and air. That is, tilted angles θ1, θ2 of the first reflective surface TIR1 and the second reflective surface TIR2 are preferably arranged to cause an included angle between an incident light beam (i.e. the emission light beam) and a normal of the first and second reflective surfaces to be larger than a critical angle to form a total reflection. In this way, it is not necessary to further form a reflective film on surfaces of the first reflective surface TIR1 and the second reflective surface TIR2.

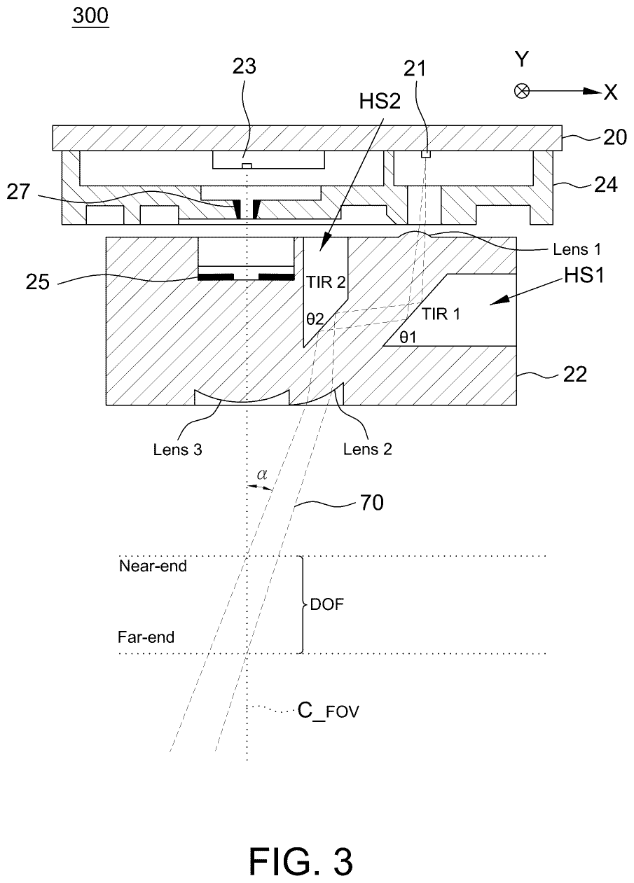

For example, the light guide 22 includes a first hollow region HS1 therein to form the first reflective surface TIR1 with the molding material of the light guide 22, and the first hollow region HS1 extends from the bottom surface (e.g., shown in FIG. 2) or the lateral surface (e.g., shown in FIG. 3) of the light guide 22 to the interface inside the light guide 22. The light guide 22 further includes a second hollow region HS2 therein to form the second reflective surface TIR2 with the molding material of the light guide 22, and the second hollow region HS2 extends from the upper surface (e.g., shown in FIG. 2) of the light guide 22 to the interface inside the light guide 22.

In the first embodiment, the second reflective surface TIR2 is between the light sensor 23 and the first reflective surface 21 as well as the light source 21 in a transverse direction (e.g., X-direction). In is seen from FIGS. 2 and 1 that an included angle α between the illumination light beam 80 and the center line C__{FOV} is smaller than the included angle θ shown in FIG. 1 such that the operable working range DOF is increased. In the first embodiment, the illumination light beam 80 is described by using a collimated light beam as an example.

Please refer to FIG. 3, it is a cross sectional view of a navigation sensor 300 according to a second embodiment of the present disclosure. The main difference between the navigation sensor 300 and the navigation sensor 200 of the first embodiment is that the illumination light beam 70 of the navigation sensor 300 is described by using a divergent light beam as an example. It is seen from FIGS. 3 and 2 that the operable working range DOF of the navigation sensor 300 is larger than that of the navigation sensor 200. The navigation sensor 300 is preferably adapted to the aspect that requires a large working range DOF but does not require steady power of the illumination light beam 70 over a longitudinal distance.

In addition, the navigation sensor 300 further includes an aperture stop 25 arranged in the light guide 22 and opposite to the light sensor 23 and the third lens Lens3, and the aperture stop 25 is used to limit amount of light entering the light sensor 23. In one aspect, the aperture stop 25 is a component independently manufactured from the light guide 22, and the aperture stop 25 is attached to the light guide 22 after being manufactured. In another aspect, the aperture stop 25 is directly formed on the light guide 22 by using a second molding process.

The navigation sensor 300 further includes a field stop 27 arranged on the light blocking member 24 and opposite to the light sensor 23 and the third lens Lens3, and the field stop 27 is used to shape a field of view of the light sensor 23. The aperture stop 25 and the field stop 27 are used to block stray light from impinging onto the light sensor 23 to improve the signal-to-noise ratio. Similarly, the field stop 27 is attached to the light blocking member 24 after being manufactured or directly formed on the light blocking member 24 by molding process.

The aperture stop 25 and the field stop 27 shown in FIG. 3 are also adaptable to the navigation sensor 200 in FIG. 2 so as to realize purposes of blocking stray light and improving the signal-to-noise ratio.

It should be mentioned that although FIGS. 2 and 3 show that the first hollow region HS1 for forming the first reflective surface TIR1 is extended in a longitudinal direction or a transverse direction, the present disclosure is not limited thereto. As long as an included angle between the incident light beam and a normal of the first reflective surface TIR1 is larger than the critical angle, an extension direction of the first hollow region HS1 is not particularly limited. The critical angles of different material with respect to air are known to the art and thus details thereof are not described herein.

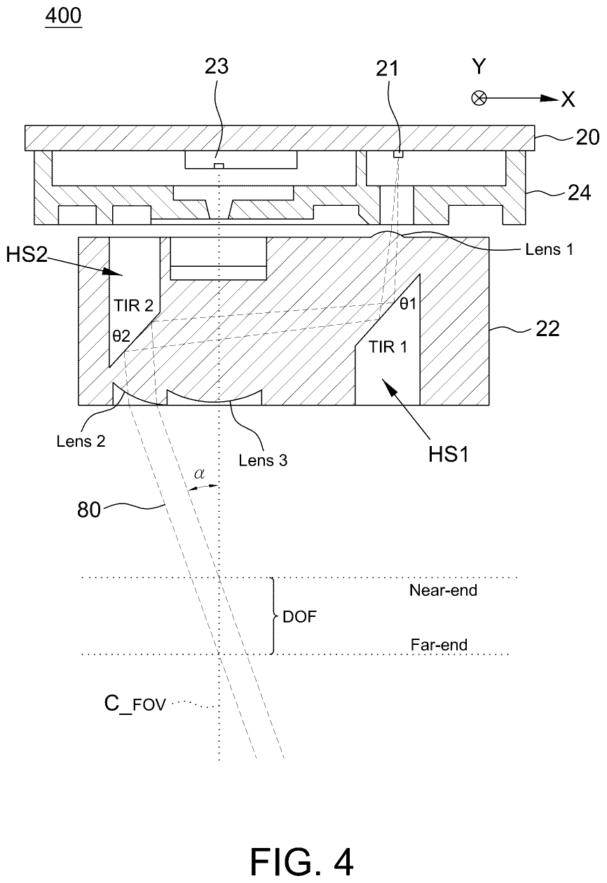

Please refer to FIG. 4, it is a cross sectional view of a navigation sensor 400 according to a third embodiment of the present disclosure. The main difference between the navigation sensor 400 and the navigation sensor 200 of the first embodiment is that the light sensor 23 is located between the second reflective surface TIR2 and the first reflective surface TIR1 as well as the light source 21 in a transverse direction (e.g., X-direction) in FIG. 4. Meanwhile, as the second lens Lens2 is preferably opposite to the second reflective surface TIR2, the light sensor 23 is located between the second lens Lens2 and the first reflective surface TIR1 as well as the light source 21 in a transverse direction (e.g., X-direction).

In addition, in the third embodiment, the first reflective surface TIR1 is a total reflection surface formed by an interface between the first hollow region HS1 and the molding material of the light guide 22 as previously shown in FIGS. 2 and 3. Meanwhile, the illumination light beam 80 is shown as a collimated light beam. The benefit of the collimated light beam is to ensure the light beam power not to change over the propagation distance. Other components not further being described in the third embodiment are identical to the navigation sensor 200 of the first embodiment, and thus details thereof are not repeated herein.

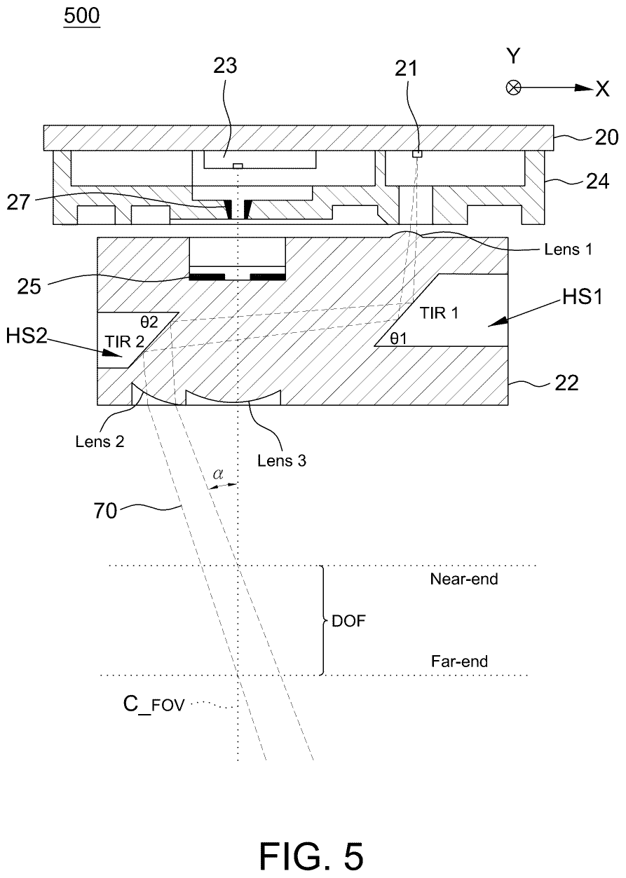

Please refer to FIG. 5, it is a cross sectional view of a navigation sensor 500 according to a fourth embodiment of the present disclosure. The main difference between the navigation sensor 500 and the navigation sensor 300 of the second embodiment is that the light sensor 23 is located between the second reflective surface TIR2 and the first reflective surface TIR1 as well as the light source 21 in a transverse direction (e.g., X-direction) in FIG. 5. Meanwhile, as the second lens Lens2 is preferably opposite to the second reflective surface TIR2, the light sensor 23 is located between the second lens Lens2 and the first reflective surface TIR1 as well as the light source 21 in a transverse direction (e.g., X-direction).

In the fourth embodiment, the first reflective surface TIR1 is a total reflection surface formed by an interface between the first hollow region HS1 and the molding material of the light guide 22 as previously shown in FIGS. 2 and 3. The second reflective surface TIR2 is a total reflection surface formed by an interface between the second hollow region HS2 and the molding material of the light guide 22 as shown in FIGS. 4 and 5. In the third and fourth embodiments, the first hollow region HS1 and the second hollow region HS2 are longitudinally extended from the upper surface of the light guide 22, transversally extended from the lateral surface of the light guide 22 or extended in other directions into the inner part of the light guide 22 without particular limitations. Meanwhile, the illumination light beam 70 is shown as a divergent light beam so as to increase the operable working range compared with the navigation sensor 400 of the third embodiment. Other components not further being described in the fourth embodiment are identical to the navigation sensor 300 of the second embodiment, and thus details thereof are not repeated herein.

The aperture stop 25 and the field stop 27 shown in FIG. 5 are also adaptable to the navigation sensor 400 in FIG. 4 so as to realize purposes of blocking stray light and improving the signal-to-noise ratio.

Although the above first to fourth embodiments are described in the way that the second reflective surface TIR2 is between the light sensor 23 and the first reflective surface TIR1 in the X-direction, or the second reflective surface TIR2 and the first reflective surface TIR1 are respectively at two sides of the light sensor 23 in the X-direction, the present disclosure is not limited thereto. Please refer to FIG. 6, in other aspects, the second reflective surface TIR2 may be arranged adjacent to the light sensor, e.g., inside the region R__{TIR2} in FIG. 6 (e.g., between the solid and dashed lines), and is not limited to those shown in FIGS. 2 to 5. It is appreciated that because the second lens Lens2 is preferably opposite to the second reflective surface TIR2, the second lens Lens2 is also inside the region R__{TIR2} in the transverse direction.

In the present disclosure, the second lens Lens2 and the third lens Lens3 are formed by hollowing a part of molding material of the light guide 22 in the molding process.

It should be mentioned that although the embodiments of the present disclosure are described in the way that a single light source is used, the present disclosure is not limited thereto. In other aspects, the navigation sensor of the present disclosure includes more than one light source, and emission light beams of the light sources are reflected toward the second reflective surface by a single first reflective surface or different first reflective surfaces. More than one illumination light beam, which is reflected by the second reflective surface and leaving the light guide, are partially overlapped in the longitudinal direction so as to further increase the longitudinal working range of the navigation sensor.

It should be mentioned that although the embodiments of the present disclosure are described in the way that the first reflective surface and the second reflective surface are used to conduct the total internal reflection, the present disclosure is not limited thereto. In other aspects, surfaces of the first reflective surface and the second reflective surface are respectively further formed with a reflective film to realize the purpose of the light reflection. In this case, the arrangement of tilted angles of the first reflective surface and the second reflective surface is no longer required to consider the critical angle for forming the total reflection such that the arrangement freedom of the first reflective surface and the second reflective surface can be increased.

As mentioned above, in conventional navigation sensors, due to the opto-mechanical design constraints, the operable working range is limited by a large angle of the illumination light beam. Accordingly, the present disclosure further provides a navigation sensor (e.g., FIGS. 2 to 5) in which a light guide is arranged with at least two reflective surfaces to cause an emission light beam to have multiple reflections inside the light guide such that an illumination light beam of the navigation sensor is closer to a light sensor compared with conventional navigation sensors. In this way, an illumination angle of the illumination light beam is effectively reduced to increase the working range. In addition, an aperture stop may further be arranged to control amount of light entering the light sensor, and a field stop may further be arranged to shape a field of view of the light sensor so as to reduce stray light influence and improve the signal-to-noise ratio.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A navigation sensor, comprising:
a substrate;
a light sensor, arranged on the substrate;
a light source, arranged on the substrate and located at a side of the light sensor, and configured to generate an emission light beam; and
a light guide, comprising a first lens, a first reflective surface, a second reflective surface and a second lens, wherein the emission light beam enters the light guide via the first lens, the first reflective surface is opposite the first lens and configured to transversely reflect the emission light beam inside the light guide, and the second reflective surface is configured to reflect the reflected emission light beam toward the second lens to generate an illumination light beam leaving the light guide via the second lens,
wherein the second reflective surface is located between the light sensor and the first reflective surface in a transverse direction.

2. The navigation sensor as claimed in claim 1, further comprising:
an aperture stop, opposite to the light sensor and configured to limit amount of light impinging onto the light sensor; and
a field stop, opposite to the light sensor and configured to shape a field of view of the light sensor.

3. The navigation sensor as claimed in claim 1, wherein the illumination light beam is a divergent light beam or a collimated light beam.

4. The navigation sensor as claimed in claim 1, wherein the light guide further comprises a third lens opposite the light sensor.

5. The navigation sensor as claimed in claim 1, wherein
the first lens is a convex lens, the first reflective surface is a plano-surface, the second reflective surface is a plano-surface, and the second lens is a convex lens,
the first lens is a convex lens, the first reflective surface is a concave surface, the second reflective surface is a plano-surface, and the second lens is a convex lens,
the first lens is a plano-lens, the first reflective surface is a concave surface, the second reflective surface is a concave surface, and the second lens is a convex lens,
the first lens is a plano-lens, the first reflective surface is a concave surface, the second reflective surface is a concave surface, and the second lens is a tilted plano-lens, a wedge or a prism,
the first lens is a concave lens, the first reflective surface is a concave surface, the second reflective surface is a plano-surface, and the second lens is a convex lens,
the first lens is a concave lens, the first reflective surface is a concave surface, the second reflective surface is a concave surface, and the second lens is a convex lens, or
the first lens is a concave lens, the first reflective surface is a concave surface, the second reflective surface is a concave surface, and the second lens is a tilted plano-lens.

6. The navigation sensor as claimed in claim 1, wherein the first reflective surface and the second reflective surface are total internal reflection surfaces formed by an interface between molding material of the light guide and air.

7. The navigation sensor as claimed in claim 6, wherein
the light guide further comprises a first hollow region configured to form the first reflective surface, and
the first hollow region extends from a bottom surface or a lateral surface of the light guide to the interface inside the light guide.

8. A navigation sensor, comprising:
a substrate;
a light sensor, arranged on the substrate;
a light source, arranged on the substrate and located at a side of the light sensor, and configured to generate an emission light beam; and
a light guide, comprising a first lens, a first reflective surface, a second reflective surface and a second lens, wherein the emission light beam enters the light guide via the first lens, the first reflective surface is opposite the first lens and configured to transversely reflect the emission light beam inside the light guide, and the second reflective surface is configured to reflect the reflected emission light beam toward the second lens to generate an illumination light beam leaving the light guide via the second lens,
wherein the light sensor is located between the second reflective surface and the first reflective surface in a transverse direction.

9. The navigation sensor as claimed in claim 8, further comprising:
an aperture stop, opposite to the light sensor and configured to limit amount of light impinging onto the light sensor; and
a field stop, opposite to the light sensor and configured to shape a field of view of the light sensor.

10. The navigation sensor as claimed in claim 8, wherein the illumination light beam is a divergent light beam or a collimated light beam.

11. The navigation sensor as claimed in claim 8, wherein the light guide further comprises a third lens opposite the light sensor.

12. The navigation sensor as claimed in claim 8, wherein
the first lens is a convex lens, the first reflective surface is a plano-surface, the second reflective surface is a plano-surface, and the second lens is a convex lens,
the first lens is a convex lens, the first reflective surface is a concave surface, the second reflective surface is a plano-surface, and the second lens is a convex lens,
the first lens is a plano-lens, the first reflective surface is a concave surface, the second reflective surface is a concave surface, and the second lens is a convex lens,
the first lens is a plano-lens, the first reflective surface is a concave surface, the second reflective surface is a concave surface, and the second lens is a tilted plano-lens, a wedge or a prism,
the first lens is a concave lens, the first reflective surface is a concave surface, the second reflective surface is a plano-surface, and the second lens is a convex lens,
the first lens is a concave lens, the first reflective surface is a concave surface, the second reflective surface is a concave surface, and the second lens is a convex lens, or
the first lens is a concave lens, the first reflective surface is a concave surface, the second reflective surface is a concave surface, and the second lens is a tilted plano-lens.

13. The navigation sensor as claimed in claim 8, wherein the first reflective surface and the second reflective surface are total internal reflection surfaces formed by a first interface and a second interface between molding material of the light guide and air.

14. The navigation sensor as claimed in claim 13, wherein
the light guide further comprises a first hollow region and a second hollow region configured to respectively form the first reflective surface and the second reflective surface,
the first hollow region extends from a bottom surface or a lateral surface of the light guide to the first interface inside the light guide, and
the second hollow region extends from an upper surface or the lateral surface of the light guide to the second interface inside the light guide.

15. A light guide of a navigation sensor, the light guide comprising:
an upper surface and a bottom surface;
a first lens, located at the upper surface, and configured to receive an emission light beam of a light source;
a first reflective surface, opposite to the first lens, and configured to transversally reflect the emission light beam coming from the first lens inside the light guide;
a second lens, located at the bottom surface; and
a second reflective surface, opposite to the second lens, and configured to reflect the reflected emission light beam toward the second lens,
wherein the first reflective surface and the second reflective surface are total internal reflection surfaces formed by a first interface and a second interface between molding material of the light guide and air.

16. The light guide as claimed in claim 15, wherein the second reflective surface is located between the light sensor and the first reflective surface in a transverse direction.

17. The light guide as claimed in claim 15, wherein the light sensor is located between the second reflective surface and the first reflective surface in a transverse direction.

18. The light guide as claimed in claim 15, wherein
the light guide further comprises a first hollow region and a second hollow region configured to respectively form the first reflective surface and the second reflective surface,
the first hollow region extends from the bottom surface or a lateral surface of the light guide to the first interface inside the light guide, and
the second hollow region extends from the upper surface or the lateral surface of the light guide to the second interface inside the light guide.

19. The light guide as claimed in claim 15, wherein
the first lens is a convex lens, the first reflective surface is a plano-surface, the second reflective surface is a plano-surface, and the second lens is a convex lens,
the first lens is a convex lens, the first reflective surface is a concave surface, the second reflective surface is a plano-surface, and the second lens is a convex lens,
the first lens is a plano-lens, the first reflective surface is a concave surface, the second reflective surface is a concave surface, and the second lens is a convex lens,
the first lens is a plano-lens, the first reflective surface is a concave surface, the second reflective surface is a concave surface, and the second lens is a tilted plano-lens, a wedge or a prism,
the first lens is a concave lens, the first reflective surface is a concave surface, the second reflective surface is a plano-surface, and the second lens is a convex lens,
the first lens is a concave lens, the first reflective surface is a concave surface, the second reflective surface is a concave surface, and the second lens is a convex lens, or
the first lens is a concave lens, the first reflective surface is a concave surface, the second reflective surface is a concave surface, and the second lens is a tilted plano-lens.

20. The light guide as claimed in claim 15, further comprising:
a third lens, located at the bottom surface, and
an aperture stop, opposite to the third lens.
